(19) United States
(12) Patent Application Publication
(10) Pub. No.: US 2023/0093014 A1
(43) Pub. Date: Mar. 23, 2023

(54) Gasket Installation Guide

(71) Applicant: Tim Fleet, Atoka, TN (US)

(72) Inventor: Tim Fleet, Atoka, TN (US)

(21) Appl. No.: 17/480,995

(22) Filed: Sep. 21, 2021

(51) Int. Cl. F16J 15/06

(52) U.S. Cl. CPC F16J 15/061

(57) ABSTRACT

A gasket installation guide and method of use wherein the gasket installation guide is used to aid in the insertion of rubber gaskets into flair connector comprising a body that is inserted into the flair connector to align the center hole that passes through the body with the female flare fitting of the flair connector, so that the rubber gasket can be easily installed.

### STATEMENT REGARDING FEDERALLY SPONSORED RESEARCH OR DEVELOPMENT

Not Applicable

### CROSS-REFERENCE TO RELATED APPLICATIONS

Not Applicable

### REFERENCE TO SEQUENCE LISTING, A TABLE, OR A COMPUTER PROGRAM LISTING COMPACT DISC

Not Applicable

### Field of the Invention

A gasket installation guide used to aid in the installation of a rubber gasket which seals the joint at a system access female flare fitting to a service hose.

### Background of the Invention

When installing the sealing gasket used to complete the connection between a male flare fitting on a piping system to a female flare hose connection used to gain servicing access to these systems, the confined space of the female flare hose connection and the size of the gasket with respect to the opening into which it is inserted make for difficult installation. The present disclosure aids in the installation of a gasket into a female flare hose connection by causing the gasket to be slightly compressed prior to insertion. Extending the gasket slightly beyond the end of the guide further aids in the alignment of the gasket with the female flare hose connection. With this useful and proper positioning via this installation guide, the push rod is used to complete the gasket's insertion.

### SUMMARY OF THE INVENTION

The present disclosure reveals a gasket installation guide to aid in the insertion a gasket into a female flare hose connection as well as a method of use of the gasket installation guide. The gasket installation guide consists of a body with a tapered center hole passing though the body and a pushrod. At one end, the center hole is at least the same diameter as the interior diameter of the female flare fitting into which the gasket will be inserted. The center hole is tapered towards the end that aligns with the female flare fitting to reduce the diameter of the gasket to slightly smaller than the female flare fitting into which the gasket will be inserted. When the body of the guide is inserted into the sleeve of the flare hose connection, the center hole aligns with the opening of the female flare fitting into which the gasket will be inserted. Once the body is positioned and the center hole is aligned, the pushrod is used to push the gasket into place. Having the gasket protrude beyond the end of the gasket installation guide further aids in the alignment of the gasket installation guide with the female flare fitting.

### BRIEF DESCRIPTION OF THE SEVERAL VIEWS OF THE DRAWING

FIG. 1 is an image of a gasket installation guide including body and pushrod;

FIG. 2 is an image of the body of the gasket installation guide including the upper portion and the lower portion and threading on the upper portion;

FIG. 3 is a cross section of the gasket installation guide showing the taper of the hole;

FIG. 4 is an image of the body of the gasket installation guide including handles;

FIG. 5A is an image the pushrod including a grip;

FIG. 5B is an image of the pushrod including a loop for a grip; and

FIG. 6 is a line diagram of the method of use of the gasket installation guide.

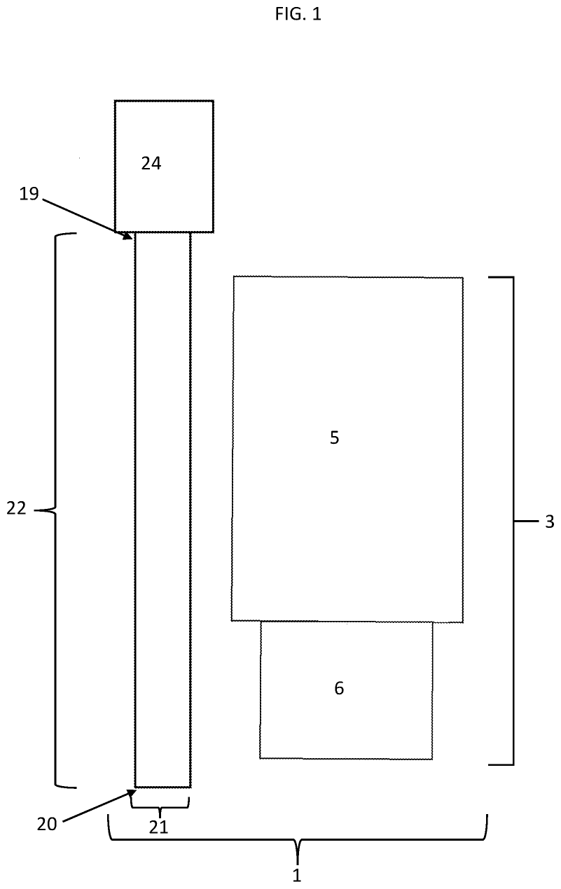

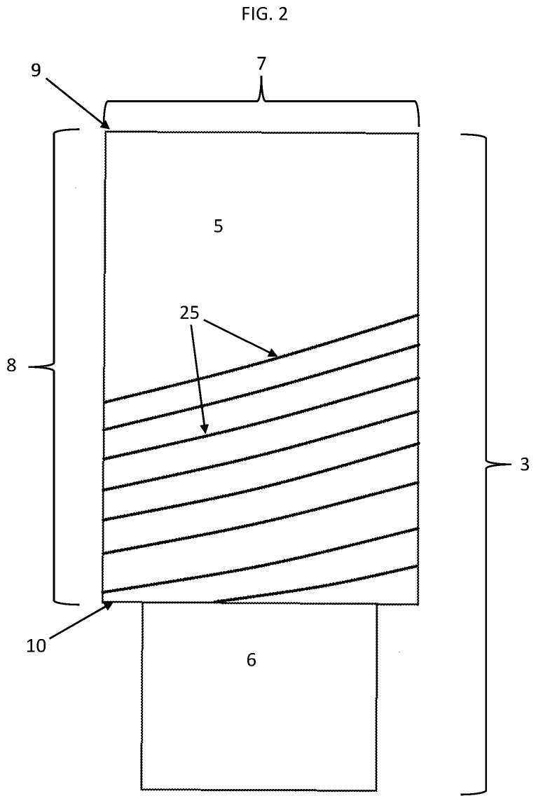

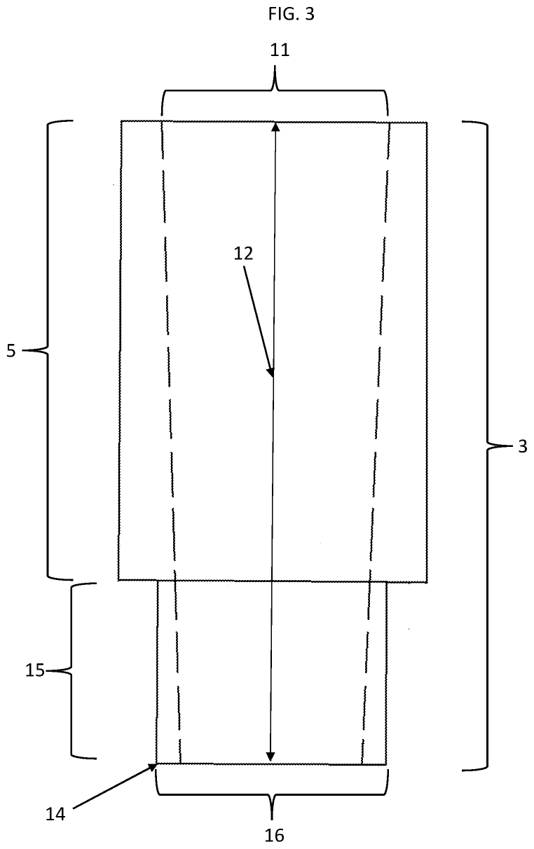

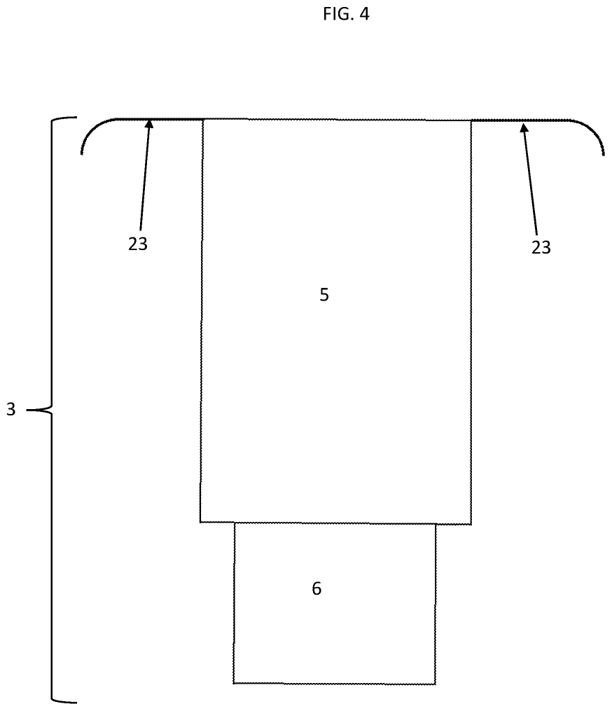

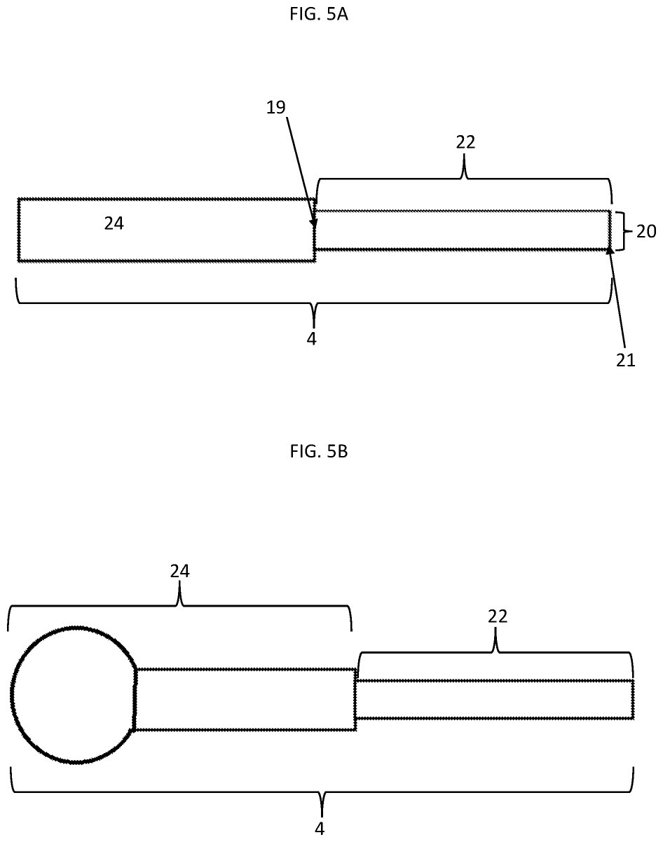

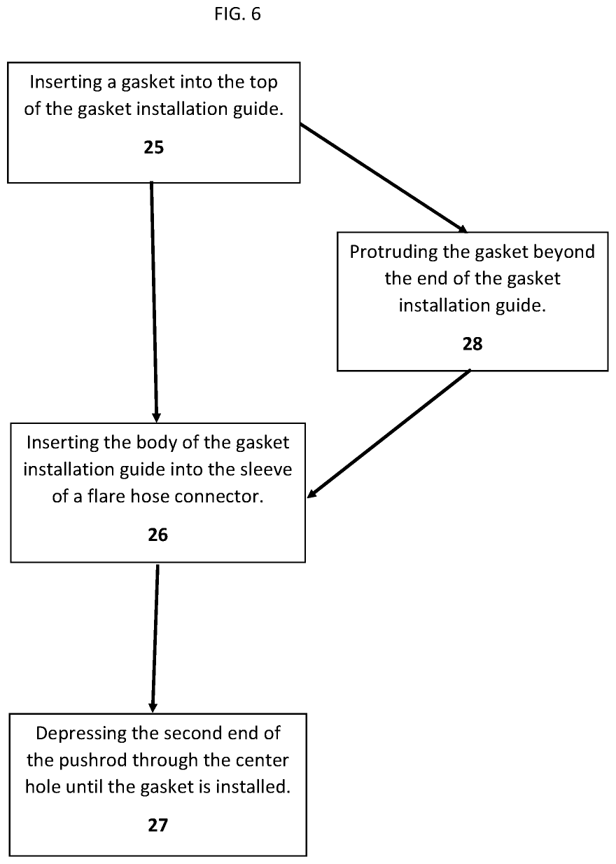

### DETAILED DESCRIPTION OF THE INVENTION

The present disclosure reveals a gasket installation guide 1 to aid in the insertion of a gasket into a female flare fitting of a flare hose connector, said gasket installation guide 1 comprising a body 3 and a pushrod 4. The body 3 and pushrod 4 being made from at least one of plastic, iron, steel, aluminum, copper, brass, nickel, or wood.

The body 3 consists of an upper portion 5 and a lower portion 6. The upper portion 5 consists of an outer diameter 7, a height 8, a top 9, a bottom 10, and a center hole 11. The outer diameter 7 of the upper portion 5 is equal to the inner diameter of the female flare fitting into which the gasket installation guide 1 is to be inserted. The center hole 11 is located in the center of the top 9 of the upper portion 5, consists of a length 12 that extends perpendicularly through the upper portion 5 and the lower portion 6 and tapers from the top 9 of the upper portion 5 to the lower face 14 of the lower portion 6. The upper portion 5 has a height 8 greater than the depth of the female flare fitting into which the gasket installation guide 1 is the be inserted, so as to allow easy insertion and removal;

The lower portion 6 of the gasket installation guide 1 comprises a lower face 14, a depth 15, an outer diameter 16, extends out from bottom 10 of the upper portion 5, and has the center hole 11 pass through the upper face 13 and the lower face 14.

At the top 9 of the upper part 5, the diameter 17 of the center hole 11 is larger than the inner diameter of the female flare fitting into which the gasket is to be inserted but not so large as to allow the allow the gasket to rotate within the center hole 11 to allow the hole through the gasket to no longer align with the length of the center hole 11. The center hole 11 tapers from the top 9 of the upper portion to the lower face 14 of the lower portion 6 and is designed to slightly compress the gasket prior to insertion so as to make insertion easier.

The pushrod 4 comprises a first end 19, a second end 20, a diameter 21, and a length 22. The diameter 21 of the pushrod 4 is such that the pushrod 4 can pass through the entire length 12 of the center hole while still pushing the gasket. The length 21 of the pushrod 4 is greater than the length 12 of the center hole 11 so as to allow for easy operating of the pushrod 4 into and through the center hole 11.

The gasket installation guide 1 may further consist of a plurality of handles 23 attached to the upper portion 5 of the gasket installation guide 1, wherein the plurality of handles 23 means one or more handles.

The gasket installation guide 1 may further consist of a grip 24 on the pushrod 4, said grip 23 may include but not be limited to a thickening of the diameter of the pushrod near the first end, a loop near the first end, or an extension near the first end.

The gasket installation guide 1 may further consist of threading 25 on the upper portion 5 of the gasket installation guide 1 so that the gasket installation guide 1 can be screwed into the sleeve of the flair connector.

The method of use of the gasket installation guide 1 comprising inserting a gasket into the top of the gasket installation guide 25, inserting the body of the gasket installation guide, lower portion first, into the female flare fitting of a flare hose connector until the lower portion of the gasket installation guide aligns with the female flare fitting of the flare hose connector 26, and depressing the second end of the pushrod through the center hole until the gasket is installed 27.

Protruding the gasket beyond the end of the gasket installation guide to aid in the alignment of the gasket installation guide with the female flare fitting 28.

What is claimed:

1. A gasket installation guide to aid in the insertion of a gasket into a female flare fitting of a flare hose connector, said gasket installation guide comprising:
a gasket installation guide, comprising a body and a pushrod;
the body being made from at least one of plastic, iron, steel, aluminum, copper, brass, nickel, or wood;
the body pushrod being made from at least one of plastic, iron, steel, aluminum, copper, brass, nickel, or wood;
the body consisting of an upper portion and a lower portion;
the upper portion consists of an outer diameter, a height, a top, a bottom, and a center hole;
the outer diameter of the upper portion is equal to the inner diameter of the female flare fitting into which the gasket installation guide is to be inserted;
the center hole is located in the center of the top of the upper portion, consists of a length that extends perpendicularly through the upper portion and the lower portion;
the upper portion has a length greater than the depth of the sleeve into which the gasket installation guide is the be inserted, so as to allow easy insertion and removal;
the lower portion of the gasket installation guide consists of an upper face, a lower face, a depth, an outer diameter, extends out from bottom of the upper portion, and has the center hole pass through the upper face and the lower face;
at the top of the upper portion diameter of the center hole is larger than the inner diameter of the female flare fitting into which the gasket is to be inserted but not so large as to allow the allow the gasket to rotate within the center hole and allow the hole through the gasket to no longer align with the length of the center hole;
the center hole tapers from the top of the upper portion to the lower face of the lower portion;
the pushrod has a first end, a second end, a diameter, and a length;
the diameter of the pushrod allows the pushrod to be extended though the length of the center hole while pushing the gasket through the center hole; and
the length of the pushrod is greater than the length of the center hole so as to allow for easy operating of the pushrod into and out of the center hole.

2. The gasket installation guide of claim 1 further comprising a plurality of handles attached to the upper portion of the gasket installation guide.

3. The gasket installation guide of claim 2 further comprising a handle on the pushrod.

4. The gasket installation guide of claim 3 further comprising threading on the upper portion of the gasket installation guide.

5. The gasket installation guide of claim 1 further comprising a plurality of handles attached to the upper portion of the gasket installation guide.

6. The gasket installation guide of claim 5 further comprising threading on the upper portion of the gasket installation guide.

7. The gasket installation guide of claim 1 further comprising a handle on the pushrod.

8. The gasket installation guide of claim 7 further comprising threading on the upper portion of the gasket installation guide.

9. The gasket installation guide of claim 1 further comprising threading on the upper portion of the gasket installation guide.

10. A method of use of the gasket installation guide as disclosed in claims 1-9 wherein the method of installation comprises:
inserting a gasket into a top of the gasket installation guide;
inserting the body of the gasket installation guide, lower portion first, into the sleeve of a flare hose connector until the lower portion of the gasket installation guide aligns with the female flare fitting of the flare hose connector; and
depressing the second end of the pushrod through the center hole until the gasket is installed.

11. The method of use of the gasket installation guide wherein having the gasket protrude beyond the end of the gasket installation guide aids in the alignment of the gasket installation guide with the female flare fitting.
